(19) United States
(12) Patent Application Publication
(10) Pub. No.: US 2026/0280657 A1
(43) Pub. Date: Sep. 17, 2026

(54) CONFIGURATIONS FOR CHANNEL STATE INFORMATION REPORTING

(71) Applicant: ZTE Corporation, Shenzhen (CN)

(72) Inventors: Meng MEI, Shenzhen (CN); Bo GAO, Shenzhen (CN); Guangyu JIANG, Shenzhen (CN); Minqiang ZOU, Shenzhen (CN)

(21) Appl. No.: 19/683,168

(22) Filed: May 20, 2026

Related U.S. Application Data
(63) Continuation of application No. PCT/CN2023/136790, filed on Dec. 6, 2023.

(51) Int. Cl. H04B 7/06; H04W 56/00

(52) U.S. Cl. CPC H04B 7/0626; H04W 56/001

(57) ABSTRACT

Techniques are described for configuring channel state information (CSI) reporting in wireless communication systems. The disclosed methods and systems enable reporting CSI for both a single frequency network (SFN) and coherent joint transmission (CJT). An example wireless communication method includes receiving, by a wireless device from a network node, a channel state information (CSI) reporting configuration. In this example method, the CSI reporting configuration configures at least one CSI-RS (reference signal) resource in at least one CSI-RS resource set or group. The method continues with the wireless device determining, based on the CSI reporting configuration, a number of CSI processing units (CPUs), and performing, based on the number of CPUs, a CSI reporting procedure.

### CROSS-REFERENCE TO RELATED APPLICATION

This application is a continuation and claims priority to International Application No. PCT/CN2023/136790, filed on Dec. 6, 2023, the disclosure of which is hereby incorporated by reference herein in its entirety.

### TECHNICAL FIELD

This disclosure is directed generally to digital wireless communications.

### BACKGROUND

Mobile telecommunication technologies are moving the world toward an increasingly connected and networked society. In comparison with the existing wireless networks, next generation systems and wireless communication techniques will need to support a much wider range of use-case characteristics and provide a more complex and sophisticated range of access requirements and flexibilities.

Long-Term Evolution (LTE) is a standard for wireless communication for mobile devices and data terminals developed by 3rd Generation Partnership Project (3GPP). LTE Advanced (LTE-A) is a wireless communication standard that enhances the LTE standard. The 5th generation of wireless system, known as 5G, advances the LTE and LTE-A wireless standards and is committed to supporting higher data-rates, large number of connections, ultra-low latency, high reliability and other emerging business needs.

### SUMMARY

In existing systems, channel state information (CSI) feedback determines Multiple-Input Multiple-Output (MIMO) transmission performance, so it plays a very important role in the entire MIMO design. Techniques are disclosed for CSI reporting in wireless communication systems, which advantageously improve system performance, and can be implemented for both a single frequency network (SFN) and coherent joint transmission (CJT).

In an example aspect, a wireless communication method includes receiving, by a wireless device from a network node, a CSI reporting configuration. In this example, the CSI reporting configuration configures at least one CSI-RS (reference signal) resource in at least one CSI-RS resource set or group. The method continues with the wireless device determining, based on the CSI reporting configuration, a number of CSI processing units (CPUs), and performing, based on the number of CPUs, a CSI reporting procedure.

In another example aspect, a wireless communication method includes transmitting, by a network node to a wireless device, a CSI reporting configuration. In this example, the CSI reporting configuration configures at least one CSI-RS (reference signal) resource in at least one CSI-RS resource set or group. Furthermore, the wireless device is configured to determine, upon receiving the CSI reporting configuration, a number of CSI processing units (CPUs), and perform a CSI reporting procedure based thereon.

In yet another example aspect, the above-described methods are embodied in the form of processor-executable code and stored in a non-transitory computer-readable storage medium. The code included in the computer readable storage medium when executed by a processor, causes the processor to implement the methods described in this patent document.

In yet another example embodiment, a device that is configured or operable to perform the above-described methods is disclosed.

The above and other aspects and their implementations are described in greater detail in the drawings, the descriptions, and the claims.

### BRIEF DESCRIPTION OF THE DRAWING

FIG. 1 shows an example of a single frequency network (SFN)/coherent joint transmission (CJT)-based downlink transmission.

FIGS. 2 and 3 show examples of sequential and cyclic mappings, respectively, of channel state information (CSI)-reference signal (RS) resources with the same indices in multiple CSI-RS sets and/or groups.

FIGS. 4 and 5 show examples of sequential and cyclic mappings, respectively, of CSI-RS resources with different indices in multiple CSI-RS sets and/or groups.

FIGS. 6 and 7 are flowcharts of example wireless communication methods.

FIG. 8 shows an exemplary block diagram of a hardware platform that may be a part of a network device or a communication device.

FIG. 9 shows an example of wireless communication including a base station (BS) and user equipment (UE) based on some implementations of the disclosed technology.

### DETAILED DESCRIPTION

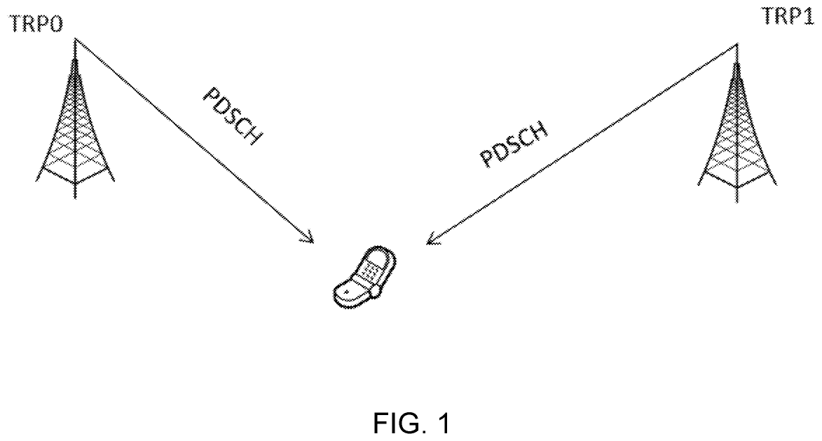

In a single frequency network (SFN) or coherent joint transmission (CJT), two or more transmission-reception points (TRPs) transmit the same Physical Downlink Shared Channel (PDSCH) to one UE (or more generally, a wireless device) on the same time-domain and frequency-domain resources, as shown in FIG. 1.

In a typical downlink transmission (e.g., PDSCH), channel state information (CSI) reporting, and the corresponding channel state information (CSI)-reference signal (RS) resources for the CSI reporting, are configured in existing wireless communication systems. When a UE receives a CSI reporting configuration, UE measures a reference signal (RS) in CSI-RS resources indicated in the CSI reporting configuration, and reports back corresponding information (e.g., channel mode parameters) according to the configured CSI-RS or a Synchronization/PBCH (Physical Broadcast Channel) signal block (SSB).

In existing wireless system implementations, CSI reporting parameters include at least one of a CSI-RS resource index (or indicator) (CRI), a rank index (RI), a precoding matrix index (PMI) that includes a wideband indication (i1), a channel quality index (CQI), a layer indicator (LI), a reference signal received power (RSRP), an SS/PBCH resource block index (ssb-Index). These parameters are supported in the following configurations:
cri-RI-PMI-CQI,
cri-RI-i1,
cri-RI-i1-CQI,
cri-RI-CQI
cri-RSRP,
ssb-Index-RSRP, and/or
cri-RI-LI-PMI-CQI.

The current specification also supports Doppler-CSI reporting, which provides the UE with channel or precoding information. As part of processing a CSI report, existing systems define CSI processing units (CPUs) based on the number of symbols, as follows:
O_{CPU}=0 for a CSI report with CSI-ReportConfig with higher layer parameter reportQuantity set to ‘none’ and CSI-RS-ResourceSet with higher layer parameter trs-Info configured
O_{CPU}=1 for a CSI report with CSI-ReportConfig with higher layer parameter reportQuantity set to ‘cri-RSRP’, ‘ssb-Index-RSRP’, ‘cri-SINR’, ‘ssb-Index-SINR’, ‘cri-RSRP-Index’, ‘ssb-Index-RSRP-Index’, ‘cri-SINR-Index’, ‘ssb-Index-SINR-Index’ or ‘none’ (and CSI-RS-ResourceSet with higher layer parameter trs-Info not configured)
O_{CPU}=(Y+1)·X, for a CSI report with CSI-ReportConfig with higher layer parameter reportQuantity set to ‘tdcp’ and with number of delays Y configured by higher layer parameter Y, where the value of X∈{1, 2} is reported by UE capability.
for a CSI report with CSI-ReportConfig with higher layer parameter reportQuantity set to ‘cri-RI-PMI-CQI’, ‘cri-RI-i1’, ‘cri-RI-i1-CQI’, ‘cri-RI-CQI’, or ‘cri-RI-LI-PMI-CQI’,
   if max {μ_{PDCCH}, μ_{CSI-RS}, μ_{UL}}≤3, and if a CSI report is aperiodically triggered without transmitting a PUSCH with either transport block or HARQ-ACK or both when L=0 CPUs are occupied, where the CSI corresponds to a single CSI with wideband frequency-granularity and to at most 4 CSI-RS ports in a single resource without CRI report and where codebookType is set to ‘typeI-SinglePanel’ or where reportQuantity is set to ‘cri-RI-CQI’, O_{CPU}=N_{CPU},
   if a CSI-ReportConfig is configured with codebookType set to ‘typeI-SinglePanel’ and the corresponding CSI-RS Resource Set for channel measurement is configured with two Resource Groups and N Resource Pairs, O_{CPU}=X·N+M, where X is the number of CPUs occupied by a pair of CMRs subject to mTRP-CSI-numCPU-r17 and M is defined in clause 5.2.1.4.2,
   if a CSI-ReportConfig contains a list of L sub-configurations provided by the higher layer parameter csi-ReportSubConfigList,

$${O}_{CPU} = {\sum }_{i = 1}^{L} {K}_{s}^{i}$$

for periodic CSI reporting, where

$${K}_{s}^{i}$$

is the total number or CSI-RS resources corresponding to the i-th sub-configuration.

$${O}_{CPU} = {\sum }_{i = 1}^{N} {K}_{s}^{i}$$

for aperiodic and semi-persistent CSI reporting, where

$${K}_{s}^{i}$$

is the total number of CSI-RS resources corresponding to the i-th sub-configuration, and where the i-th sub-configuration is from N indicated sub-configurations out of L sub-configurations contained in a CSI-ReportConfig, where N≤L and N≥1.
if a CSI-ReportConfig is configured with the higher layer parameter reportQuantity set to ‘cri-RI-PMI-CQI’, codebookType set to ‘typeII-CJT-r18’ or ‘typeII-CJT-PortSelection-r18’ and the corresponding NZP-CSI-RS-Resource Set for channel measurement is configured with 1<N_{TRP}≤4 resources, O_{CPU}=X·N_{TRP}, where X∈{1, 1.5, 2} is reported by UE capability indication,
if a CSI-ReportConfig is configured with the higher layer parameter reportQuantity set to ‘cri-RI-PMI-CQI’ and with code bookType set to ‘typeII-Doppler-r18’ or ‘typeII-Doppler-PortSelection-r18’,
if the corresponding CSI-RS Resource Set for channel measurement is aperiodic and configured with K CSI-RS resources, O_{CPU}=Y₁·K, where Y₁∈{⅔, 1, 2, 3} is reported by UE capability indication,
if the corresponding CSI-RS Resource Set for channel measurement is periodic or semi-persistent and configured with a single CSI-RS resource, O_{CPU}=4 for N₄=1 and O_{CPU}=Y₂·N₄≥4, for N₄>1, where the value of N₄ is configured by the higher layer parameter N₄, and Y₂={⅔, 1, 2, 3} is reported by UE capability indication,
otherwise, O_{CPU}=Kₛ, where Kₛ is the number of CSI-RS resources in the CSI-RS resource set for channel measurement.

In certain scenarios, e.g., with multiple TRPs as previously described in the context of FIG. 1, the UE may receive the PDSCH from multiple TRPs, and delay- and Doppler-related parameters associated with each of the multiple TRPs may be different. For example, in SFN or CJT, two TRPs transmit the same PDSCH or jointly transmit the same PDSCH. In these cases, the gNodeB (or more generally, a network node) needs the related delay information and/or Doppler information. Embodiments of the disclosed technology provide methods and system that enable a UE to determine whether and how to inform the gNodeB (gNB) of the related delay and/or Doppler information, determine the number of CSI computing units needed for the CSI reporting, and provide time-sensitive CSI reporting.

The example headings for the various sections below are used to facilitate the understanding of the disclosed subject matter and do not limit the scope of the claimed subject matter in any way. Accordingly, one or more features of one example section can be combined with one or more features of another example section. Furthermore, 5G terminology is used for the sake of clarity of explanation, but the techniques disclosed in the present document are not limited to 5G technology only, and may be used in wireless systems that implemented other protocols.

### 1 Embodiment #1 Examples

In some embodiments, a UE receives, from a gNB, a CSI reporting configuration that configures one or more channel state information (CSI)-reference signal (RS) resources in one or more CSI-RS sets or groups. The UE determines, based on the CSI reporting configuration, a number of CSI processing units (CPUs). Using the CPUs, the UE measures the reference signal (RS) in the configured (or indicated) CSI-RS resources, and then performs CSI reporting. The CSI reporting is configured as Doppler reporting or delay reporting. In an example, the CPU occupation time starts from the first symbol of the earliest of a demodulation reference signal (DMRS)/PDSCH used for channel measurement and resources for interference measurement and ends at the last symbol of the UL channel that carries the CSI report.

In some embodiments, gNB configures the CSI reporting as Doppler reporting, delay reporting, or Doppler and delay reporting for CJT. Herein, configuring the CSI reporting includes at least one of:
Radio Resource Control (RRC) configures CJT Doppler or delay reporting,
RRC configures the number of reported Doppler or delay as being greater than 1,
RRC configures CSI reporting with more than one CSI-RS resource set or more than one CSI-RS resource group in one CSI-RS resource set, or
RRC configures CSI reporting with Doppler or delay reporting being a CJT transmission by default.

For coherent joint transmission (CJT), more than one TRP is used for downlink transmissions, and one CSI-RS resource set (or one CSI-RS resource group in a CSI-RS resource set) is associated with one transmission-reception point (TRP) or one transmission configuration indicator (TCI) state. Herein, multiple CSI-RS resource groups are configured within the one CSI-RS resource set. If more than one CSI-RS resource set is configured, each CSI-RS resource set is associated with one TRP or TCI state; herein, CSI-RS resource groups may not be configured or there may be one CSI-RS resource group per CSI-RS resource set.

In some embodiments, and if delay or Doppler reporting is configured, the number of CPUs (O_{CPU}) is determined based on at least one of: a number of CSI-RS resources of in one CSI-RS resource set or group (Y), a number of configured CSI-RS resource sets or groups (X), a calculation factor (a) related to the number of configured CSI-RS resources in one set or group, or determined by the configuration of CSI reporting as Doppler or delay, a scaling factor (Z) reported by the UE capability, a calculation factor (b) associated with CSI-RS resources that correspond to one CSI-RS resource set or group, or a parameter (c) related to the minimum number of CPUs in the CSI reporting procedure.

If delay or Doppler reporting is configured, the UE is configured to determine the number of CPUs (O_{CPU}) as:

$${O}_{CPU} = ( Y - a ) \cdot b \cdot X \cdot Z + c .$$

Herein, Y is the number of CSI resources in one CSI-RS resource set or group, X is the number of configured or indicated CSI-RS resource sets or groups, Z is real number reported by the UE capability (e.g., Z has a value of 1 or 2), a is calculation factor associated with one or more CSI-RS resources that correspond to one CSI report or CSI-RS resource set (with different values being supported for Doppler or delay reporting, e.g., a has a value of 1, 2, or 3 for Doppler reporting, and a value of 0, 1, 2, or 3 for delay reporting; alternatively, the same values are used for Doppler or delay reporting), b is another calculation factor associated with one or more CSI-RS resources that correspond to one CSI report or CSI-RS resource set such that the value (Y−a)*b is the number of resources or reports in one CSI-RS resource set or group (e.g., b has a value of 1, ½, ⅓, ⅔, ¼, or ¾), and c is a real number representing a minimum number of CPUs that are used for CSI processing (e.g., c has a value of 0 or 1).

In some embodiments, the number of CSI-RS resources is configured by a higher layer parameter, e.g., Radio Resource Control (RRC).

In some embodiments, the number of CSI-RS resources in one CSI-RS resource set is predetermined or a default (constant) value, e.g., 1, 2, 3 or 4.

In some embodiments, the number of CPUs (O_{CPU}) is determined by at least one of: a number of reported delay or Doppler (Y), a calculation factor (e) corresponding to Y and the number of CSI-RS resources or groups, a scaling factor (b) associated with determining an actual number of CPUs corresponding to Y, a number of CSI-RS resources in one group or CSI-RS resource set (X), a parameter (c) related to the minimum number of CPUs in the CSI reporting procedure, or a scaling factor (Z) reported by the UE capability.

In this example, the UE is configured to determine the number of CPUs as:

$${O}_{CPU} = ( Y + e ) * b * Z + c , or \\ {O}_{CPU} = ( Y + e ) * b * X * Z + c .$$

Herein, Y is the number of reported Doppler or delay, e is a calculation factor, which is conjunction with scaling factor b, determines the number of actual number of reported Doppler or delay for CPU computations. As above, Z is real number reported by the UE capability (e.g., Z has a value of 1 or 2), c is a real number representing a minimum number of CPUs that are used for CSI processing (e.g., c has a value of 0 or 1), and X is the number of CSI-RS resources in one CSI-RS resource set or group that corresponds to one TRP.

In some embodiments, and as described below, certain parameters in the CSI report can be ignored based on whether the CSI reporting is Doppler reporting or delay reporting.

For Doppler reporting, multiple CSI-RS resources are configured from one or more CSI-RS resource sets, and the following cases provide examples of determining the number of CPUs required for CSI processing and reporting.
1) O_{CPU}=1 for a CSI report that is configured by Radio Resource Control (RRC).
2) O_{CPU}=Y·X·Z, where Y is the number of CSI-RS resource in one CSI-RS resource set or group, X is the number of configured or indicated CSI-RS resource sets or groups, and Z is real number reported by the UE capability (e.g., Z has a value of 1 or 2).
3) O_{CPU}=2·X·Z, where X is the number of configured or indicated CSI-RS resource sets or groups, and Z is real number reported by the UE capability (e.g., Z has a value of 1 or 2). In this case, the number of CSI-RS resources in one set or group is assumed to be 2.
4) O_{CPU}=(Y−a)·X·Z, where Y is the number of CSI-RS resources in one CSI-RS resource set or group, X is the number of configured or indicated CSI-RS resource sets or groups, Z is real number reported by the UE capability (e.g., Z has a value of 1 or 2), a is calculation factor associated with one or more CSI-RS resources that correspond to one CSI report or CSI-RS resource set (e.g., a has a value of 0, 1, 2, or 3). In this example, at least two CSI-RS resources are used for one Doppler calculation, and in case that a=1, Y CSI-RS resources are configured (or allocated) for (Y−1) Doppler.
5) O_{CPU}=(Y−a)·b·X·Z, where Y is the number of CSI-RS resource in one CSI-RS resource set or group, X is the number of configured or indicated CSI-RS resource sets or groups, Z is real number reported by the UE capability (e.g., Z has a value of 1 or 2), a is calculation factor associated with one or more CSI-RS resources that correspond to one CSI report or CSI-RS resource set (e.g., a has a value of 0, 1, 2, or 3). In this example, at least two CSI-RS resources are used for one Doppler calculation, and in case that a=1, Y CSI-RS resources are configured (or allocated) for (Y−1) Doppler. Furthermore, b is another calculation factor associated with one or more CSI-RS resources that correspond to one CSI report or CSI-RS resource set such that the value (Y−a)*b is the number of resources or reports in one CSI-RS resource set or group (e.g., b has a value of 1, ½, ⅓, ⅔, ¼, or ¾).
6) O_{CPU}=Y·Z, where Y is the number of reported Doppler, and Z is real number reported by the UE capability (e.g., Z has a value of 1 or 2). In this example, one Doppler is reported for one CSI-RS resource set or group corresponding to one TRP.
7) O_{CPU}=Y·X·Z, where Y is the number of reported Doppler, X is the number of CSI-RS resources in one group or set corresponding to one TRP, and Z is real number reported by the UE capability (e.g., Z has a value of 1 or 2). In this example, one Doppler is reported for one CSI-RS resource set or group.
8) O_{CPU}=(Y+1)·Z, where Y is the number of reported Doppler differences between two or more CSI-RS resource sets or groups, and Z is real number reported by the UE capability (e.g., Z has a value of 1 or 2). In this example, one Doppler is reported as a difference between two CSI-RS resource sets or groups.
9) O_{CPU}=(Y+1)·X·Z, where Y is the number of reported Doppler differences between two or more CSI-RS resource sets or groups, X is the number of CSI-RS resources in one group or set corresponding to one TRP, and Z is real number reported by the UE capability (e.g., Z has a value of 1 or 2). In this example, one Doppler is reported as a difference between two CSI-RS resource sets or groups.

For delay reporting, multiple CSI-RS resources are configured from one or more CSI-RS resource sets, and the following cases provide examples of determining the number of CPUs required for CSI processing and reporting.
1) O_{CPU}=1 for a CSI report that is configured by Radio Resource Control (RRC).
2) O_{CPU}=Y·X·Z, where Y is the number of CSI-RS resource in one CSI-RS resource set or group, X is the number of configured or indicated CSI-RS resource sets or groups, and Z is real number reported by the UE capability (e.g., Z has a value of 1 or 2).
3) O_{CPU}=X·Z, where X is the number of configured or indicated CSI-RS resource sets or groups, and Z is real number reported by the UE capability (e.g., Z has a value of 1 or 2). In this case, the number of CSI-RS resources is assumed to be 1.
4) O_{CPU}=(Y−a)·X·Z, where Y is the number of CSI-RS resource in one CSI-RS resource set or group, X is the number of configured or indicated CSI-RS resource sets or groups, Z is real number reported by the UE capability (e.g., Z has a value of 1 or 2), a is calculation factor associated with one or more CSI-RS resources that correspond to one CSI report or CSI-RS resource set (e.g., a has a value of 0, 1, 2, or 3). In this example, at least one CSI-RS resource is used for one delay calculation.
5) O_{CPU}=(Y−a)·b·X·Z, where Y is the number of CSI-RS resource in one CSI-RS resource set or group, X is the number of configured or indicated CSI-RS resource sets or groups, Z is real number reported by the UE capability (e.g., Z has a value of 1 or 2), a is calculation factor associated with one or more CSI-RS resources that correspond to one CSI report or CSI-RS resource set (e.g., a has a value of 0, 1, 2, or 3). In this example, at least one CSI-RS resource is used for one delay calculation. Furthermore, b is another calculation factor associated with one or more CSI-RS resources that correspond to one CSI report or CSI-RS resource set such that the value (Y−a)*b is the number of resources or reports in one CSI-RS resource set or group (e.g., b has a value of 1, ½, ⅓, ⅔, ¼, or ¾).
6) O_{CPU}=Y·Z, where Y is the number of reported delays, and Z is real number reported by the UE capability (e.g., Z has a value of 1 or 2). In this example, one delay is reported for one CSI-RS resource set or group.
7) O_{CPU}=(Y+1)·Z, where Y is the number of reported delay differences between two or more CSI-RS resource sets or groups, and Z is real number reported by the UE capability (e.g., Z has a value of 1 or 2). In this example, one delay is reported as a difference between two CSI-RS resource sets or groups.
8) O_{CPU}=Y·Z, where Y is the number of reported delays, X is the number of CSI-RS resources in one group or set corresponding to one TRP, and Z is real number reported by the UE capability (e.g., Z has a value of 1 or 2). In this example, one delay is reported for one CSI-RS resource set or group.
9) O_{CPU}=(Y+1)·X·Z, where Y is the number of reported delay differences between two or more CSI-RS resource sets or groups, X is the number of CSI-RS resources in one group or set corresponding to one TRP, and Z is real number reported by the UE capability (e.g., Z has a value of 1 or 2). In this example, one delay is reported as a difference between two CSI-RS resource sets or groups.

### 2 Embodiment #2 Examples

In some embodiments, and when delay and Doppler reporting is configured, the UE can determine the number of CPUs based on the total number of delay and Doppler reporting. In an example, the number of CPUs are equal to the total number. Alternatively, the number of CPUs can be greater than or less than the total number, e.g., the delay or Doppler reporting for the same set of CSI-RS resources are counted only once for CPU determination. Alternatively, a new parameter can be included for the CPU computation, e.g., with a value of 1.5 or 2 for delay and Doppler reporting.

In some examples, when this new parameter is 2, the UE can support the following cases when determining the number of CPUs.
1) O_{CPU}=1 for a CSI report that is configured by Radio Resource Control (RRC).
2) O_{CPU}=2·Y·X·Z, where Y is the number of CSI-RS resource in one CSI-RS resource set or group, X is the number of configured or indicated CSI-RS resource sets or groups, and Z is real number reported by the UE capability (e.g., Z has a value of 1 or 2).
3) O_{CPU}=2·X·Z, where X is the number of configured or indicated CSI-RS resource sets or groups, and Z is real number reported by the UE capability (e.g., Z has a value of 1 or 2). In this case, the number of CSI-RS resource sets or groups is assumed to be 1.
4) O_{CPU}=2·(Y−a)·X·Z, where Y is the number of CSI-RS resource in one CSI-RS resource set or group, X is the number of configured or indicated CSI-RS resource sets or groups, Z is real number reported by the UE capability (e.g., Z has a value of 1 or 2), a is calculation factor associated with one or more CSI-RS resources that correspond to one CSI report or CSI-RS resource set (e.g., a has a value of 1, 2, or 3). In this example, at least two CSI-RS resources are used for one Doppler and delay calculation, and in case that a=1, Y CSI-RS resources are configured (or allocated) for (Y−1) Doppler.
5) O_{CPU}=2·(Y−a)·b·X·Z, where Y is the number of CSI-RS resource in one CSI-RS resource set or group, X is the number of configured or indicated CSI-RS resource sets or groups, Z is real number reported by the UE capability (e.g., Z has a value of 1 or 2), a is calculation factor associated with one or more CSI-RS resources that correspond to one CSI report or CSI-RS resource set (e.g., a has a value of 1, 2, or 3). In this example, at least two CSI-RS resources are used for one Doppler and delay calculation, and in case that a=1, Y CSI-RS resources are configured (or allocated) for (Y−1) Doppler. Furthermore, b is another calculation factor associated with one or more CSI-RS resources that correspond to one CSI report or CSI-RS resource set such that the value (Y−a)*b is the number of resources or reports in one CSI-RS resource set or group (e.g., b has a value of 1, ½, ⅓, ⅔, ¼, or ¾).
6) O_{CPU}=2·Y·Z, where Y is the number of reported Doppler, and Z is real number reported by the UE capability (e.g., Z has a value of 1 or 2). In this example, one Doppler and delay is reported for one CSI-RS resource set or group.
7) O_{CPU}=2. (Y+1). Z, where Y is the number of reported Doppler differences between two or more CSI-RS resource sets or groups, and Z is real number reported by the UE capability (e.g., Z has a value of 1 or 2). In this example, one Doppler and delay is reported as a difference between two CSI-RS resource sets or groups.
8) O_{CPU}=2·Y·X·Z, where Y is the number of reported Doppler, X is the number of CSI-RS resources in one group or set corresponding to one TRP, and Z is real number reported by the UE capability (e.g., Z has a value of 1 or 2). In this example, one Doppler and delay is reported for one CSI-RS resource set or group.
9) O_{CPU}=2·(Y+1)·X·Z, where Y is the number of reported Doppler differences between two or more CSI-RS resource sets or groups, X is the number of CSI-RS resources in one group or set corresponding to one TRP, and Z is real number reported by the UE capability (e.g., Z has a value of 1 or 2). In this example, one Doppler and delay is reported as a difference between two CSI-RS resource sets or groups.

### 3 Embodiment #3 Examples

In some embodiments, and as previously discussed, multiple CSI-RS resources are configured for one CSI reporting with delay or Doppler. Herein, one CSI-RS resource set or CSI-RS resource group in one CSI-RS resource set is associated with one TRP or TCI state. In an example, at least two CSI-RS resources are supported in one CSI-RS resource set or group for Doppler estimation, and at least one CSI-RS resource is supported in one CSI-RS resource set or group for delay estimation.

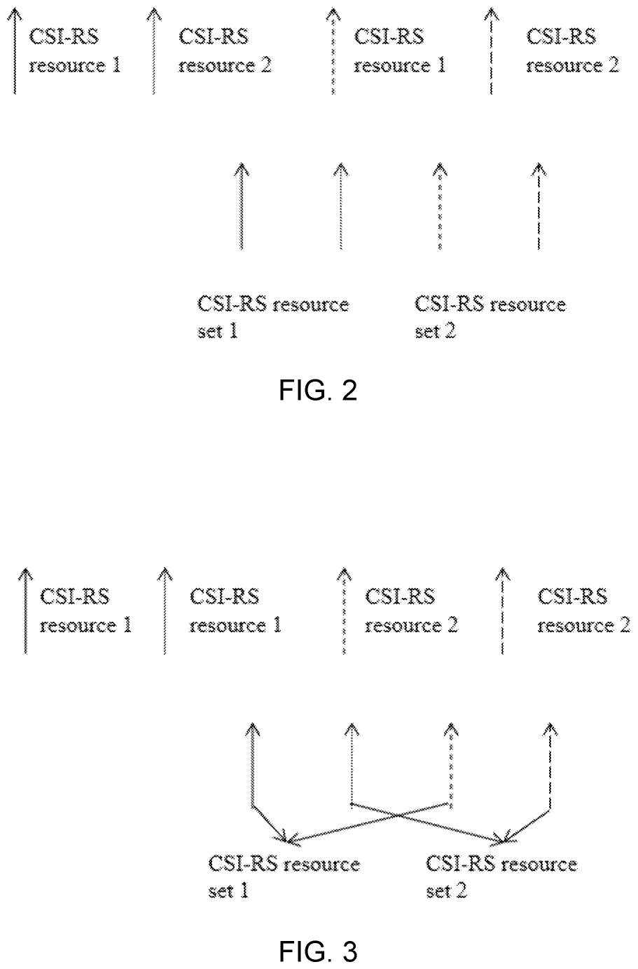

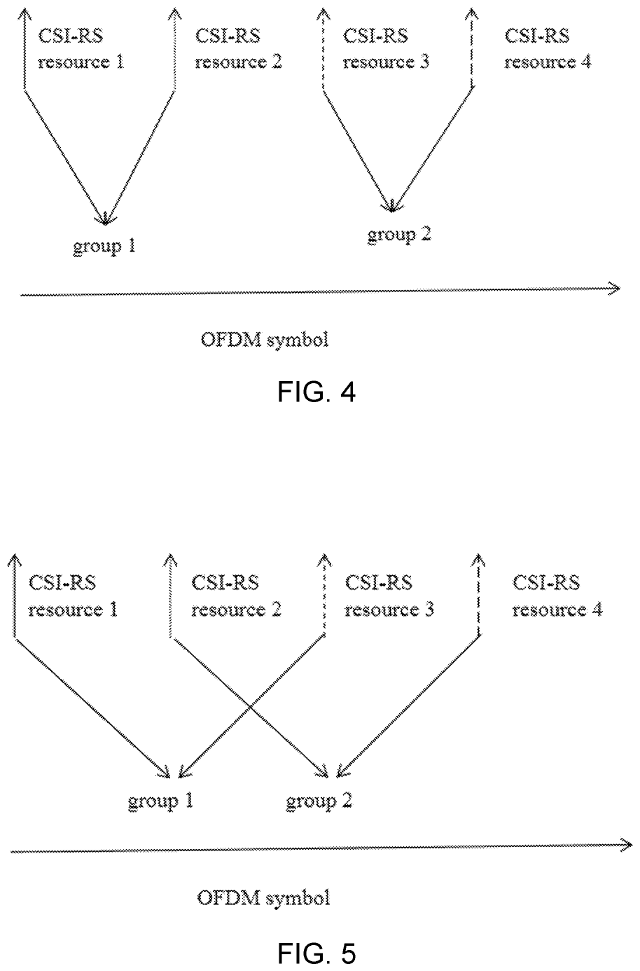

In an example, the following cases are considered for determining the number of CPUs by a UE that is associated with one transmission-reception point (TRP):
1) If multiple CSI-RS resource sets are configured, e.g., up to 4 CSI-RS resource sets, each CSI-RS resource set is associated with one TRP or TCI state, and the CSI-RS resources in one CSI-RS resource set are associated with one TRP or TCI state. These CSI-RS resources are used for delay or Doppler calculations, e.g., 2 or 4 CSI-RS resources in one CSI-RS resource set can be mapped either sequentially or cyclically. In an example, CSI-RS resources with the same indexes may be in different CSI-RS resource sets, as shown in FIGS. 2 and 3. Alternatively, CSI-RS resource with different indexes may be in different CSI-RS resource sets, as shown in FIGS. 4 and 5.
2) If only one CSI-RS resource set is configured for coherent joint transmission (CJT) delay or Doppler reporting, a number of CSI-RS groups and a total number of CSI-RS resources are configured in the one CSI-RS resource set, and the number of CSI-RS resources in a CSI-RS resource group is known to the UE. In these cases, which CSI-RS resources are associated with a first TRP or TCI state can be based on UE capability or determined by default, e.g., a first number of CSI-RS resources can be sequentially mapped as shown in FIG. 4, or a first number and (possibly non-adjacent) second number of CSI-RS resources can be cyclically mapped as shown in FIG. 5.
3) If only one CSI-RS resource set is configured for coherent joint transmission (CJT) delay or Doppler reporting, a number of CSI-RS groups and multiple CSI-RS resources in each CSI-RS resource group are configured. In an example, when multiple CSI-RS resources for CJT are configured, up to 4 CSI-RS resources can be configured for each CSI-RS resource set.

In some embodiments, if only one CSI-RS resource set or multiple CSI-RS resource groups are configured, and the CSI reporting is configured to include Doppler reporting (e.g., Doppler reporting, or delay and Doppler reporting), then at least two CSI-RS resources are configured in one CSI-RS resource group. In an example, if up to 4 CSI-RS resource groups are configured, then the total number of CSI-RS resources configured for one CSI-RS resource set is 8. In another example, if 4 CSI-RS resources are configured in one CSI-RS resource group, and up to 4 CSI-RS resource groups are supported in each CSI-RS resource set, then up to 16 CSI-RS resources can be supported in one CSI-RS resource set.

In some embodiments, and if the total number of CSI-RS resources is restricted (or constrained) not be to larger than 8 or 12, then the number of CSI-RS resources in one CSI-RS resource group or the number of CSI-RS resource groups in a CSI-RS resource set is also restricted. In an example, if up to 4 CSI-RS resource groups are configured, then 2-3 CSI-RS resources are used a CSI-RS resource group, and if up to 4 CSI-RS resources can be configured for one CSI-RS resource group, then up to 2 or 3 CSI-RS resource groups can be configured.

In some embodiments, and for CSI-RS resource mapping with delay reporting being configured, different CSI-RS resources for one CSI-RS resource set or group can be configured on different symbols in the time-domain or different resource elements (REs) in the frequency-domain. However, when Doppler reporting is configured, the CSI-RS resources for one CSI-RS resource set or group can only be mapped on different symbols in the time-domain. In some examples, the number of orthogonal frequency division multiplexing (OFDM) symbols in one slot mapped for CSI-RS resources in one CSI-RS resource set or group is restricted to not exceed 2 OFDM symbols. Under such a restriction, the total number of CSI-RS resources from all CSI-RS resource sets or groups are mapped in two neighboring slots, and CSI-RS resources from different CSI-RS resource sets or groups are mapped on different REs in the frequency-domain or different symbols in the time-domain.

In some embodiments, different CSI-RS resource sets or groups correspond to different TRPs or TCI states that share at least one of: the same number of CSI-RS resources in one CSI-RS resource set or group, the same time-domain or frequency-domain pattern among the CSI-RS resource sets or groups.

In other embodiments, different CSI-RS resource sets or groups are configured with different patterns or number of CSI-RS resources, respectively.

### 4 Methods and Implementations of the Disclosed Technology

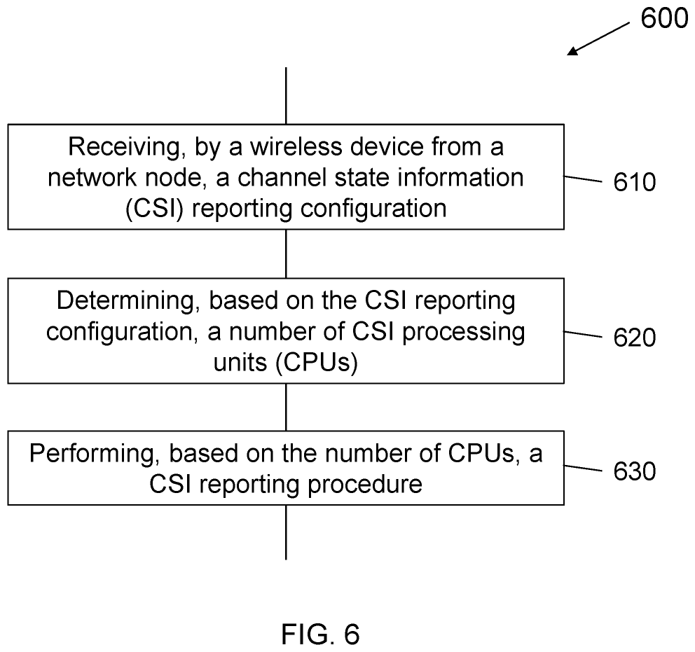

FIG. 6 shows a flowchart for an example wireless communication method 600. The method 600 includes, at operation 610, receiving, by a wireless device from a network node, a channel state information (CSI) reporting configuration. In this example, the CSI reporting configuration configures at least one CSI-RS (reference signal) resource in at least one CSI-RS resource set or group.

The method 600 includes, at operation 620, determining, based on the CSI reporting configuration, a number of CSI processing units (CPUs).

The method 600 includes, at operation 630, performing, based on the number of CPUs, a CSI reporting procedure.

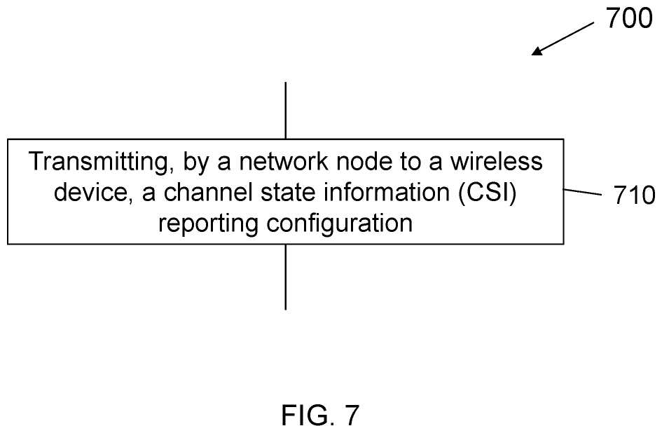

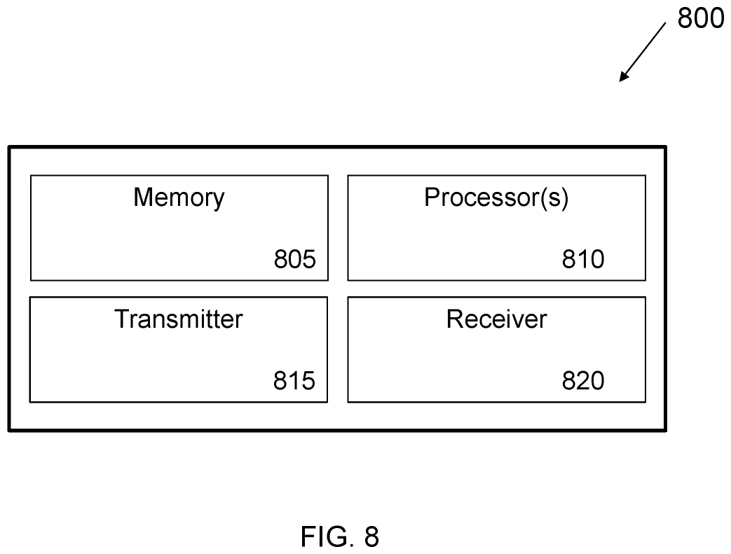

FIG. 7 shows a flowchart for an example wireless communication method 700. The method 700 includes, at operation 710, transmitting, by a network node to a wireless device, a channel state information (CSI) reporting configuration. In this example, the CSI reporting configuration configures at least one CSI-RS (reference signal) resource in at least one CSI-RS resource set or group. Furthermore, the wireless device is configured to determine, upon receiving the CSI reporting configuration, a number of CSI processing units (CPUs), and perform a CSI reporting procedure based thereon.

The described features can be implemented to further provide one or more of the following technical solutions:
1. A wireless communication method, comprising: receiving, by a wireless device from a network node, a channel state information (CSI) reporting configuration, wherein the CSI reporting configuration configures at least one CSI-RS (reference signal) resource in at least one CSI-RS resource set or group; determining, based on the CSI reporting configuration, a number of CSI processing units (CPUs); and performing, based on the number of CPUs, a CSI reporting procedure. In some examples, the number of CPUs are determined as described in Sections 1-3.
2. A wireless communication method, comprising: transmitting, by a network node to a wireless device, a channel state information (CSI) reporting configuration, wherein the CSI reporting configuration configures at least one CSI-RS (reference signal) resource in at least one CSI-RS resource set or group, wherein the wireless device is configured to determine, upon receiving the CSI reporting configuration, a number of CSI processing units (CPUs), and perform a CSI reporting procedure based thereon. In some examples, the number of CPUs are determined as described in Sections 1-3.
3. The method of solution 1 or 2, wherein the CSI reporting procedure is configured as a delay reporting procedure or a Doppler reporting procedure.
4. The method of solution 3, wherein the number of CPUs (O_{CPU}) is determined based on at least one of: a number (Y) either corresponding to CSI-RS resources in one CSI-RS resource set or group, or being a predetermined or default value, a number (X) of configured CSI-RS resource sets or groups, a first calculation factor (a) related to a number of configured CSI-RS resources in one CSI-RS resource set of group or whether the CSI reporting procedure is the delay reporting procedure or the Doppler reporting procedure, a scaling factor (Z) reported by a capability of the wireless device, a second calculation factor (b) associated with CSI-RS resources that correspond to one CSI-RS resource set or group, or a parameter (c) related to a minimum number of CPUs in the CSI reporting procedure.
5. The method of solution 4, wherein the number of CPUs (O_{CPU}) is determined as: O_{CPU}=(Y−a)×b×X×Z+c. In some examples, the method of solutions 4 and 5 is further detailed in Sections 1 and 2.
6. The method of solution 4, wherein Y is greater than 1 in case the CSI reporting procedure is the Doppler reporting procedure, wherein Z is equal to 1 or 2, wherein a is equal to 0, 1, 2, or 3, wherein b is equal to 1, ½, ⅓, ⅔, ¼, or ¾, and wherein c is equal to 0 or 1.
7. The method of solution 3, wherein the number of CPUs (O_{CPU}) is determined based on at least one of: a number (Y) of reported delay or Doppler, a calculation factor (e) corresponding to Y and a number of CSI-RS resource sets or groups, or the reported delay or Doppler that corresponds to a respective CSI-RS resource set or group, or a difference among at least two TRP sets or groups, a scaling factor (b) associated with a number of actual CPU corresponding to Y, a number (X) either corresponding to CSI-RS resources in one CSI-RS resource set or group, or being a predetermined or default value, a parameter (c) related to a minimum number of CPUs in the CSI reporting procedure, or a scaling factor (Z) reported by a capability of the wireless device.
8. The method of solution 7, wherein the number of CPUs (O_{CPU}) is determined as: O_{CPU}=(Y+e)×b×Z+c, or O_{CPU}=(Y+e)×b×X×Z+c. In some examples, the method of solutions 7 and 8 is further detailed in Sections 1 and 2.
9. The method of solution 8, wherein: e is equal to 0 in case a reported delay or Doppler corresponds to one CSI-RS resource set or group, or e is equal to 1 in case Y is reported as a delay difference or a Doppler difference between two CSI-RS resource sets or groups.
10. The method of solution 3, wherein determining the number of CPUs is further based on a total number of reported delay and Doppler, and wherein the number of CPUs used for the CSI reporting procedure is greater than or less than the total number of reported delay and Doppler.
11. The method of solution 3, wherein the CSI reporting configuration configures a plurality CSI-RS resource sets or groups corresponding to one CSI-RS resource set, and wherein each CSI-RS resource set or CSI-RS resource group from one CSI-RS resource set is associated with one transmission-reception point (TRP) or one transmission configuration indicator (TCI) state.
12. The method of solution 3, wherein at least two CSI-RS resources are configured in a CSI-RS resource set or group in case the CSI reporting procedure is the Doppler reporting procedure, and wherein at least one CSI-RS resource is configured in the CSI-RS resource set or group in case the CSI reporting procedure is the delay reporting procedure.
13. The method of solution 1, wherein the CSI-RS resource set is configured for coherent joint transmission (CJT) Doppler or delay reporting.
14. The method of solution 13, wherein CSI-RS resources corresponding to different CSI-RS resource sets or groups are mapped using a sequential scheme or a cyclic scheme, which are further detailed in Section 3.
15. The method of solution 13, wherein up to 16 CSI-RS resources are configured in the CSI-RS resource set.
16. The method of solution 13, wherein, in case a total number of CSI-RS resources is restricted to be less than 8 or 12, a number of CSI-RS resources in a CSI-RS resource group or a number of CSI-RS resource groups is restricted.
17. The method of solution 13, wherein a number of orthogonal frequency division multiplexing (OFDM) symbols in one slot mapped for the at least one CSI-RS resources in the one CSI-RS resource set or group is not greater than 2.
18. The method of solution 1, wherein a total number of CSI-RS resources in all CSI-RS resource groups or sets are mapped in one, two, or four neighboring slots.
19. The method of solution 1, wherein CSI-RS resources from different CSI-RS resource groups or sets are mapped on different resource elements (REs) in a frequency domain or on different symbols in a time domain.
20. An apparatus for wireless communication comprising a processor, configured to implement a method recited in one or more of solutions 1 to 19.
21. A non-transitory computer readable program storage medium having code stored thereon, the code, when executed by a processor, causing the processor to implement a method recited in one or more of solutions 1 to 19.

FIG. 8 shows an example block diagram of a hardware platform 800 that may be a part of a network device (e.g., base station) or a communication device (e.g., a user equipment (UE)). The hardware platform 800 includes at least one processor 810 and a memory 805 having instructions stored thereupon. The instructions upon execution by the processor 810 configure the hardware platform 800 to perform the operations described in FIGS. 6 and 7 and in the various embodiments described in this patent document. The transmitter 815 transmits or sends information or data to another device. For example, a network device transmitter can send a message to a user equipment. The receiver 820 receives information or data transmitted or sent by another device. For example, a user equipment can receive a message from a network device.

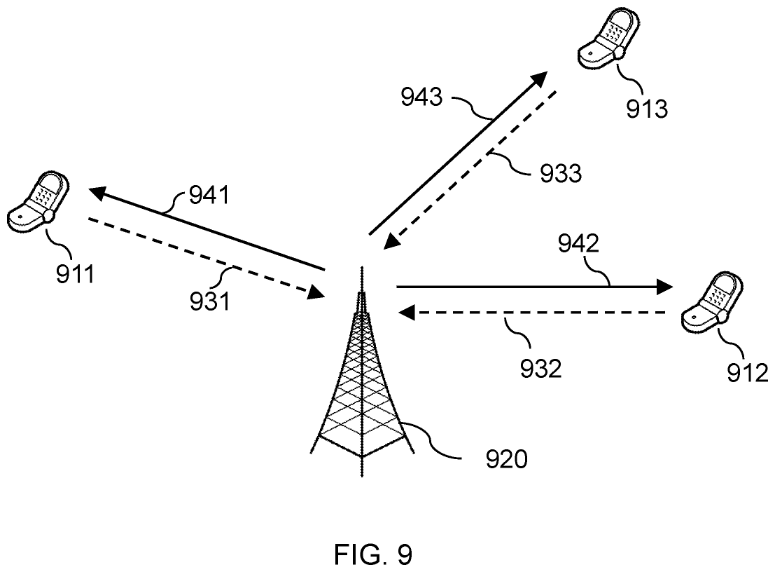

The implementations as discussed above will apply to a wireless communication. FIG. 9 shows an example of a wireless communication system (e.g., a 5G or NR cellular network) that includes a base station 920 and one or more user equipment (UE) 911, 912 and 913. In some embodiments, the UEs access the BS (e.g., the network) using a communication link to the network (sometimes called uplink direction, as depicted by dashed arrows 931, 932, 933), which then enables subsequent communication (e.g., shown in the direction from the network to the UEs, sometimes called downlink direction, shown by arrows 941, 942, 943) from the BS to the UEs. In some embodiments, the BS send information to the UEs (sometimes called downlink direction, as depicted by arrows 941, 942, 943), which then enables subsequent communication (e.g., shown in the direction from the UEs to the BS, sometimes called uplink direction, shown by dashed arrows 931, 932, 933) from the UEs to the BS. The UE may be, for example, a smartphone, a tablet, a mobile computer, a machine to machine (M2M) device, an Internet of Things (IoT) device, and so on.

Some of the embodiments described herein are described in the general context of methods or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Therefore, the computer-readable media can include a non-transitory storage media. Generally, program modules may include routines, programs, objects, components, data structures, etc. that perform particular tasks or implement particular abstract data types. Computer- or processor-executable instructions, associated data structures, and program modules represent examples of program code for executing steps of the methods disclosed herein. The particular sequence of such executable instructions or associated data structures represents examples of corresponding acts for implementing the functions described in such steps or processes.

Some of the disclosed embodiments can be implemented as devices or modules using hardware circuits, software, or combinations thereof. For example, a hardware circuit implementation can include discrete analog and/or digital components that are, for example, integrated as part of a printed circuit board. Alternatively, or additionally, the disclosed components or modules can be implemented as an Application Specific Integrated Circuit (ASIC) and/or as a Field Programmable Gate Array (FPGA) device. Some implementations may additionally or alternatively include a digital signal processor (DSP) that is a specialized microprocessor with an architecture optimized for the operational needs of digital signal processing associated with the disclosed functionalities of this application. Similarly, the various components or sub-components within each module may be implemented in software, hardware or firmware. The connectivity between the modules and/or components within the modules may be provided using any one of the connectivity methods and media that is known in the art, including, but not limited to, communications over the Internet, wired, or wireless networks using the appropriate protocols.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few implementations and examples are described, and other implementations, enhancements and variations can be made based on what is described and illustrated herein.

What is claimed is:

1. A wireless communication method, comprising:
receiving, by a wireless device from a network node, a channel state information (CSI) reporting configuration, wherein the CSI reporting configuration configures at least one CSI-RS (reference signal) resource in at least one CSI-RS resource set or group;
determining, based on the CSI reporting configuration, a number of CSI processing units (CPUs); and
performing, based on the number of CPUs, a CSI reporting procedure.

2. The wireless communication method of claim 1, wherein the number of CPUs (O_{CPU}) is determined based on at least one of:
a number (Y) of reported delay or Doppler,
a number (X) of configured CSI-RS resource sets or groups, or
a scaling factor (Z) reported by a capability of the wireless device.

3. The wireless communication method of claim 2, wherein the CSI reporting procedure is configured as a delay reporting procedure and a Doppler reporting procedure, wherein the number of CPUs (O_{CPU}) is determined as:
$${O}_{CPU} = 2 \cdot X \cdot Z , or \\ {O}_{CPU} = 2 \cdot ( Y + 1 ) \cdot Z .$$

4. The wireless communication method of claim 2, wherein the CSI reporting procedure is configured as a coherent joint transmission (CJT) delay reporting procedure or a CJT Doppler reporting procedure, and wherein the number of CPUs (O_{CPU}) is determined as:
$${O}_{CPU} = ( Y + 1 ) \cdot Z , or \\ {O}_{CPU} = Y \cdot Z .$$

5. A wireless communication method, comprising:
transmitting, by a network node to a wireless device, a channel state information (CSI) reporting configuration, wherein the CSI reporting configuration configures at least one CSI-RS (reference signal) resource in at least one CSI-RS resource set or group;
wherein the wireless device is configured to determine, upon receiving the CSI reporting configuration, a number of CSI processing units (CPUs), and perform a CSI reporting procedure based thereon.

6. The wireless communication method of claim 5, wherein the number of CPUs (O_{CPU}) is determined based on at least one of:
a number (Y) of reported delay or Doppler,
a number (X) of configured CSI-RS resource sets or groups, or
a scaling factor (Z) reported by a capability of the wireless device.

7. The wireless communication method of claim 6, wherein the CSI reporting procedure is configured as a delay reporting procedure and a Doppler reporting procedure, wherein the number of CPUs (O_{CPU}) is determined as:
$${O}_{CPU} = 2 \cdot X \cdot Z , or \\ {O}_{CPU} = 2 \cdot ( Y + 1 ) \cdot Z .$$

8. The wireless communication method of claim 6, wherein the CSI reporting procedure is configured as a coherent joint transmission (CJT) delay reporting procedure or a CJT Doppler reporting procedure, and wherein the number of CPUs (O_{CPU}) is determined as:
$${O}_{CPU} = ( Y + 1 ) \cdot Z , or \\ {O}_{CPU} = Y \cdot Z .$$

9. A wireless communication apparatus, comprising:
at least one processor configured to:
receive, by a wireless device from a network node, a channel state information (CSI) reporting configuration, wherein the CSI reporting configuration configures at least one CSI-RS (reference signal) resource in at least one CSI-RS resource set or group;
determine, based on the CSI reporting configuration, a number of CSI processing units (CPUs); and
perform based on the number of CPUs, a CSI reporting procedure.

10. The wireless communication apparatus of claim 9, wherein the number of CPUs (O_{CPU}) is determined based on at least one of:
a number (Y) of reported delay or Doppler,
a number (X) of configured CSI-RS resource sets or groups, or
a scaling factor (Z) reported by a capability of the wireless device.

11. The wireless communication apparatus of claim 10, wherein the CSI reporting procedure is configured as a delay reporting procedure and a Doppler reporting procedure, wherein the number of CPUs (O_{CPU}) is determined as:
$${O}_{CPU} = 2 \cdot X \cdot Z , or \\ {O}_{CPU} = 2 \cdot ( Y + 1 ) \cdot Z .$$

12. The wireless communication apparatus of claim 10, wherein the CSI reporting procedure is configured as a coherent joint transmission (CJT) delay reporting procedure or a CJT Doppler reporting procedure, and wherein the number of CPUs (O_{CPU}) is determined as:
$${O}_{CPU} = ( Y + 1 ) \cdot Z , or \\ {O}_{CPU} = Y \cdot Z .$$

13. A wireless communication apparatus, comprising:
at least one processor configured to:
transmit, by a network node to a wireless device, a channel state information (CSI) reporting configuration, wherein the CSI reporting configuration configures at least one CSI-RS (reference signal) resource in at least one CSI-RS resource set or group,
wherein the wireless device is configured to determine, upon receiving the CSI reporting configuration, a number of CSI processing units (CPUs), and perform a CSI reporting procedure based thereon.

14. The wireless communication apparatus of claim 13, wherein the number of CPUs (O_{CPU}) is determined based on at least one of:
a number (Y) of reported delay or Doppler,
a number (X) of configured CSI-RS resource sets or groups, or
a scaling factor (Z) reported by a capability of the wireless device.

15. The wireless communication apparatus of claim 14, wherein the CSI reporting procedure is configured as a delay reporting procedure and a Doppler reporting procedure, wherein the number of CPUs (O_{CPU}) is determined as:
$${O}_{CPU} = 2 \cdot X \cdot Z , or \\ {O}_{CPU} = 2 \cdot ( Y + 1 ) \cdot Z .$$

16. The wireless communication apparatus of claim 14, wherein the CSI reporting procedure is configured as a coherent joint transmission (CJT) delay reporting procedure or a CJT Doppler reporting procedure, and wherein the number of CPUs (O_{CPU}) is determined as:
$${O}_{CPU} = ( Y + 1 ) \cdot Z , or \\ {O}_{CPU} = Y \cdot Z .$$
